(19) United States
(12) Patent Application Publication
(10) Pub. No.: US 2015/0090288 A1
(43) Pub. Date: Apr. 2, 2015

(54) Flocked Elastic Hair Band and Method of Manufacture

(71) Applicant: Goody Products Inc., Atlanta, GA (US)

(72) Inventor: Stan Chudzik, Alpharetta, GA (US)

(21) Appl. No.: 14/389,657

(22) PCT Filed: Apr. 1, 2013
(86) PCT No.: PCT/US2013/034840

§ 371 Date: Sep. 30, 2014

Related U.S. Application Data
(60) Provisional application No. 61/618,434, filed on Mar. 30, 2012.

(51) Int. Cl. A45D 8/34; B05D 1/00; B05D 3/06; B05D 1/16

(52) U.S. Cl. CPC A45D 8/34; B05D 1/16; B05D 1/007; B05D 3/065
USPC 132/273; 427/180; 427/462; 427/558

(57) ABSTRACT

A textured elastic hair band including an elastic core substrate, a sheath of textile fibers covering the elastic core substrate, and flocking fibers secured to the sheath in which the elastic core substrate is a loop or ring shape. A method of manufacturing a textured elastic hair band includes the steps of providing an elastic core including an elastic core substrate and a sheath of textile fibers over the elastic core substrate, applying an adhesive material over an outer surface of the sheath, exposing the elastic core to flocking fibers, removing non-adhered flocking fibers from the elastic core, and curing the adhesive material. The step of applying flocking fibers can also include placing the elastic core in a flocking chamber containing the flocking fibers, applying a static electric charge, stopping the static electric charge after the period of time, and removing the flocked elastic core from the flocking chamber.

### RELATED APPLICATION DATA

This patent is related to and claims priority benefit of U.S. Provisional Patent Application 61/618,434. The entire content of this prior filed provisional application is hereby incorporated herein by reference.

### BACKGROUND

1. Field of the Disclosure

The present disclosure is generally directed to hair styling accessories, and more particularly to an elastic hair holding band with an outer flocked surface and to a method of making same.

2. Description of Related Art

Known elastic hair band products typically provide enough hold in the hair when a wearer's physical activity includes normal day to day tasks. However, as the wearer's physical activity increases, the added motion can cause an elastic band, such as when hair is retained in a ponytail hair style, to slowly slide down the ponytail during the physical activity. Hair can become loose, causing frustration to the wearer who may have to stop their activity and re-adjust or re-install the elastic band in an attempt to gain a stronger hold. The holding strength of known hair holding elastic bands and damage done to the hair is a known consumer frustration.

In order to gain sufficient hold, sometimes a wearer will install the hair band under significant tension. To accomplish this, often a user will wrap the elastic band around the ponytail or styled hair one or more additional times to really tighten the hold of the band on the hair. Over-tightening the band on the hair can exacerbate or worsen another disadvantage with existing elastic hair bands. Hair can be damaged when held by some elastic bands in some hairstyles, such as in a ponytail style. The elastic band may tend to grip and pull more hair out and cause breakage of individual hairs. An over-tightened elastic band will also tend to leave behind a noticeable bend or “dent” in the previously held hair. The hair “dent” would be in the area of the hair that was wrapped, retained, or clamped by the elastic band.

Others have tried to solve or alleviate the above noted-problems. One existing product has a rubber strand woven into a textile covering on hair retaining products including elastic hair bands and headbands. Another existing product has a linear silicone bead applied along the inside length of a flat braided elastic hair styling accessory.

The foregoing existing product designs do increase the hold in the hair so that the elastic hair band is less likely to slide out or down during physical activity. However, these products can be very aggressive when holding the hair and can cause damage to the hair. Some designs may be perceived by some consumers as being too “athletic” or too “aggressive” in appearance for general use. Thus, some consumers might not choose these products when desiring a different, more subtle, elegant, or attractive appearance.

### SUMMARY

One aspect of the present invention is a textured elastic hair band including an elastic core substrate, a sheath of textile fibers covering the elastic core substrate, and flocking fibers secured to the sheath.

In one example according to the present invention, the textile fibers can be helically woven and the sheath can cover the entire elastic core substrate.

In one example according to the present invention, the flocking fibers can be oriented generally perpendicular to the outer surface of the sheath.

In one example according to the present invention, the elastic core substrate can be a loop or ring shape.

In one example according to the present invention, the textured elastic hair band further can include an adhesive material layer on the outer surface of the sheath, the flocking fibers being adhered to the adhesive material layer.

Another aspect of the present invention is a method of manufacturing a textured elastic hair band including the steps of providing an elastic core including an elastic core substrate and a sheath of textile fibers over the elastic core substrate, applying an adhesive material over one or more portions of an outer surface of the sheath, exposing the elastic core to flocking fibers so that flocking fibers are secured to the elastic core by the adhesive material, removing non-adhered flocking fibers from the elastic core, and curing the adhesive material.

In one example according to the present invention, the method can include placing the elastic core in a flocking chamber containing the flocking fibers.

In one example according to the present invention, the method can include applying a static electric charge to the flocking fibers and the elastic core for a period of time sufficient to attract the flocking fibers to the elastic core and for the flocking fibers to adhere to the one or more portions of the outer surface of the sheath.

In one example according to the present invention, the method can include stopping the static electric charge after the period of time.

In one example according to the present invention, the method can include removing the flocked elastic core from the flocking chamber.

In one example according to the present invention, the step of applying an adhesive material can include spraying the adhesive material in liquid form onto the elastic core.

In one example according to the present invention, the step of applying an adhesive material can include dipping the elastic core into the adhesive material.

In one example according to the present invention, the method can include removing excess adhesive material from the elastic core.

In one example according to the present invention, the method can include cutting monofilament synthetic material to uniform length fibers to form the flocking fibers.

In one example according to the present invention, the method can include milling the flocking fibers to a non-uniform length.

In one example according to the present invention, the method can include selecting a flocking chamber from a group of flocking chambers each containing flocking fibers of a different color or color scheme.

In one example according to the present invention, the step of applying the flocking fibers can include operating a flocking chamber at a relative humidity in a range between about 30% and about 65% and at a temperature of about 20 degrees C. (68 degrees F.).

In one example according to the present invention, the step of removing non-adhered flocking fibers can include blowing air over the flocked elastic core to remove the non-adhered flocking fibers.

In one example according to the present invention, the step of removing non-adhered flocking fibers can include applying suction to the flocked elastic core to remove the non-adhered flocking fibers.

In one example according to the present invention, the step of removing non-adhered flocking fibers can include placing the flocked elastic core onto a vibration bed and vibrating the non-adhered flocking fibers off the flocked elastic core.

In one example according to the present invention, the step of curing can include placing the flocked elastic core in an oven.

In one example according to the present invention, the step of curing can include exposing the flocked elastic core to ultraviolet light.

In one example according to the present invention, the method can include cutting the flocked elastic core into multiple selected lengths.

In one example according to the present invention, the method can include gluing cut ends of each of the multiple selected lengths together to form multiple loop or ring shaped textured elastic hair bands.

In one example according to the present invention, the step of applying the flocking fibers can include applying an electrostatic charge to the flocking fibers and the elastic core.

In one example according to the present invention, a textured elastic hair band can include an elastic core, and flocking fibers secured to an outer surface of the elastic core.

In one example according to the present invention, the elastic core can include an elastic core substrate and a sheath of textile fibers over the elastic core substrate, and the flocking fibers can be secured to the sheath of textile fibers.

In one example according to the present invention, the flocking fibers can be secured directly to the outer surface of the elastic core by an adhesive material.

In one example according to the present invention, the flocking fibers can be oriented generally perpendicular to the outer surface of the elastic core.

In one example according to the present invention, the textured elastic hair band can have a loop or ring shape.

### BRIEF DESCRIPTION OF THE DRAWINGS

Objects, features, and advantages of the present invention will become apparent upon reading the following description in conjunction with the drawing figures, in which:

FIG. 1 shows an example of a textured elastic hair band in a loop or ring shape according to the teachings of the present invention.

FIG. 2 shows a cross-section taken along line 2-2 of a textured elastic hair band of FIG. 1.

FIG. 3 shows a close up view of a length of the elastic core portion of the textured elastic hair band of FIG. 1.

FIG. 4 shows a close up view of a length of the textured elastic hair band of FIG. 1 and in a stretched state.

FIG. 5 shows a cross-section taken along line 5-5 of the length of the textured elastic hair band of FIG. 1.

FIG. 6 shows a cross-section of an alternate example of the textured elastic hair band according to the teachings of the present invention.

FIG. 7 shows an enlarged portion of a length of the textured hair band of FIG. 6.

FIG. 8 shows a lengthwise cross section taken along line 8-8 of the textured hair band of FIG. 7.

FIG. 9 shows a flow chart of a method of manufacturing a textured hair band according to the teachings of the present invention.

FIG. 10 shows a flow chart of another example of a method of manufacturing a textured hair band according to the teachings of the present invention.

FIG. 11 shows a side view of one example of a portion of a manufacturing line for dispensing adhesive using rollers according to the method of FIG. 10.

FIG. 12 shows a perspective view of one example of a manufacturing line for the applying flocking fibers according to the method of FIG. 10.

FIG. 13 shows an alternate example of a frame for holding selected lengths of an elastic core for placing in a flocking chamber.

FIG. 14 shows a cut-away view of a flocking chamber with the frame of FIG. 13 therein.

FIG. 15 shows an alternate example of an adhesive dispensing portion of a manufacturing line for making textured elastic hair bands according to the teachings of the present invention.

FIG. 16 shows another alternate example of an adhesive dispensing portion of a manufacturing line.

FIG. 17 shows yet another alternate example of an adhesive dispensing portion of a manufacturing line.

### DETAILED DESCRIPTION OF THE DISCLOSURE

The disclosed flocked elastic hair bands and methods of manufacture solve or improve upon one or more of the above-noted and/or other problems and disadvantages with prior known hair styling accessories of this type. In one example, the disclosed elastic hair bands are flocked to produce a textured elastic product or hair band. The disclosed flocked elastic bands can also provide a more aesthetically pleasing product that can be gentler to the hair while still maintain a lighter-duty, yet stable, hold when installed in the hair. The disclosed flocked elastic hair band adds a velvet-, suede-, or velour-like texture component on an outer surface of an elastic product or hair band. The disclosed flocked textile component employs many small fibers that are cut or milled and applied to an outer surface of the elastic band. The flocking fibers create a surface on the band that produces a surface on the band that is soft, gentle, and fabric-like to the touch. The texture created by the flocking fibers can provide an adequately aggressive hold in the hair without having to over-tighten the elastic hair band that could otherwise lead to hair being damaged when installed or when removed.

“Flocking” is a process whereby a substrate is coated with an adhesive and then coated with multiple tiny, small, or minute fibers. The flocking fibers penetrate the adhesive layer, which anchors the fibers to the substrate. A “flocking” process is typically used on inelastic substrates. The disclosed invention is for flocked or textured elastic hair bands and methods of manufacturing such textured elastic hair bands.

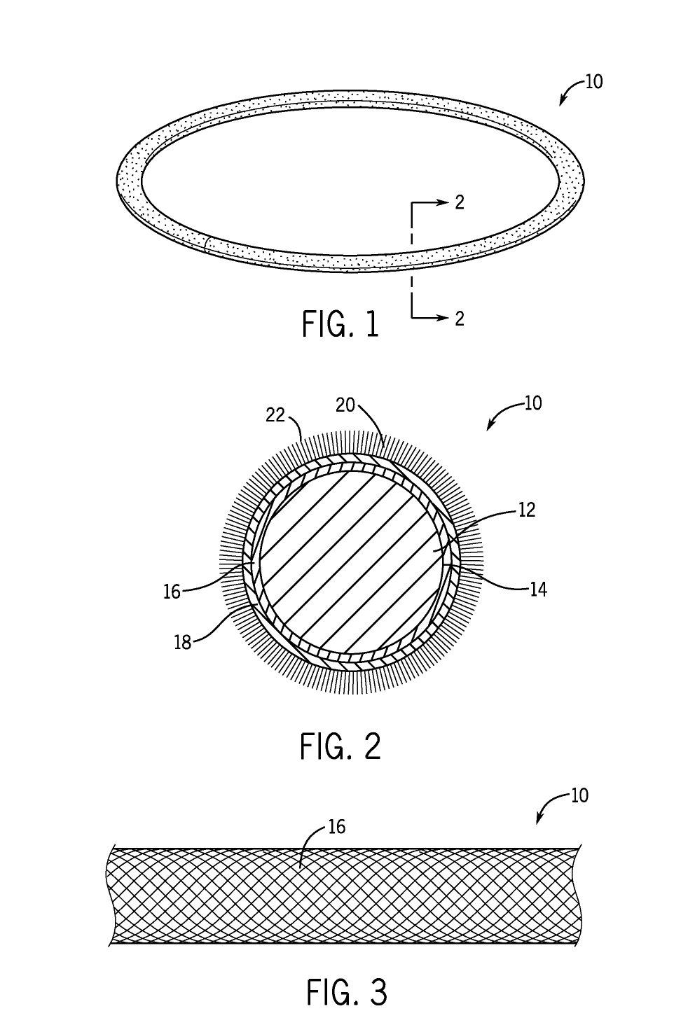

Turning now to the drawings, FIGS. 1 and 2 show an example of a textured elastic hair band 10 according to the present invention. As illustrated in the cross-section of FIG. 2, the textured elastic hair band 10 has an elastic core 12 of a substrate material with an outer surface 14. As shown in FIG. 2, a sheath 16 of the woven textile fibers or threads covers the outer surface 14. The woven textile threads can be braided or woven in a helical manner in order to form the sheath. The helically woven textile threads of the sheath can cover substantially the entire elastic core when the covered elastic core is in a relaxed, unstretched state. Such a hair band construction having an elastic core and a braided sheath is known in the art. The sheath 16 can be covered by an adhesive layer 18. Flocking fibers 20 are embedded in the adhesive layer 18. In the present example, the flocking fibers 20 can be consistently oriented perpendicular to the outer surface 14 of the elastic core 12 or substrate material. Exposed free ends of densely packed flocking fibers 20 form a textured flocked surface 22 on the textured elastic hair band 10.

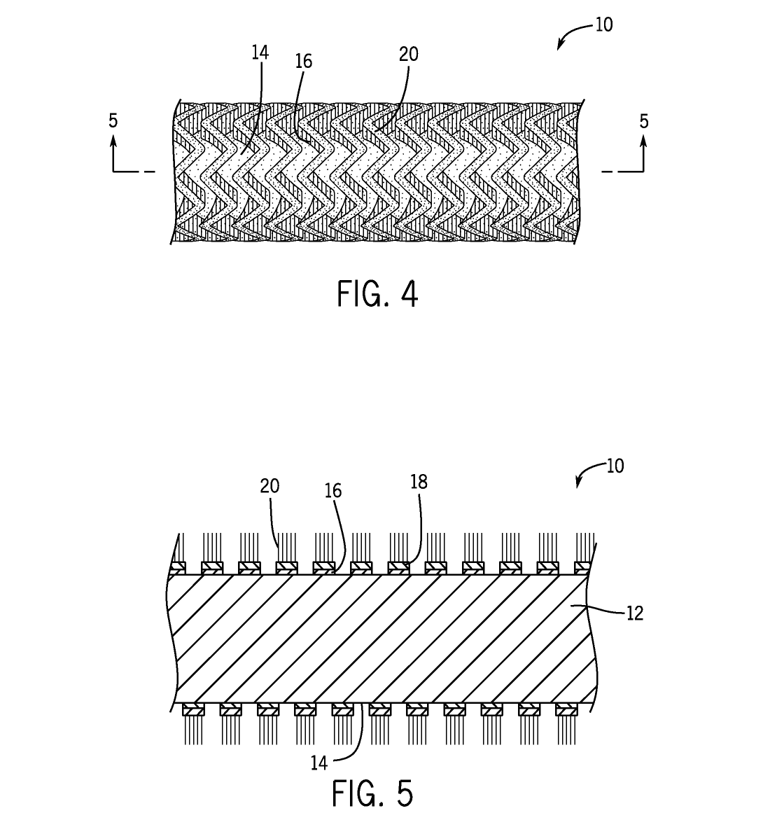

FIG. 3 shows a close up view of a length of the elastic core portion of the textured elastic hair band of FIG. 1 in which the sheath 16 has not yet been covered by the adhesive material or the flocking fibers. FIG. 4 shows a graphic representation of a close up view of a length of the textured elastic hair band 10 in a stretched state. In a stretched state, the textile threads of the woven sheath 16 may move apart as the elastic core or substrate 12 is lengthened. Because the adhesive layer 18 and hence the flocking fibers 20 are formed on the textile threads of the sheath 16, the fibers may follow the movement of the threads and form a herringbone type pattern. The lengths of the flocking fibers 20 are similar and the fibers are oriented generally perpendicular to the outer surface 14 of the substrate 12. Stippling indicates the free ends of the fibers 20 in FIG. 4. As the textile threads of the sheath 16 move apart, portions of the outer surface 14 are exposed in this example. FIG. 5 shows a cross-section of a length of the textured elastic hair band 10 shown in the stretched state of FIG. 4.

The loop or ring shaped hair bands can vary in size, depending on desired use. The elastic core 12 can be of a solid rubber or rubber-like or elastomeric material. The cross-sectional shape of the elastic core can be generally round as shown in FIG. 2. Alternatively, the shape of the elastic core can be oval, rectangular, square, or any number of alternate shapes.

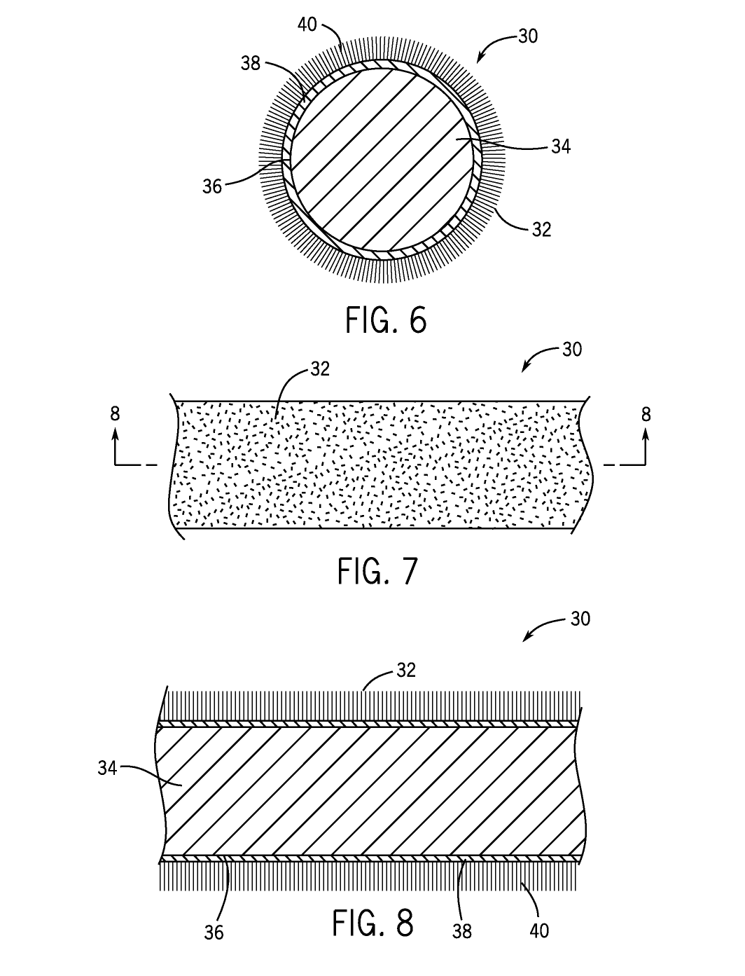

FIG. 6 shows a cross-section of an alternate textured elastic hair band 30 according to the teachings of the present invention. The elastic hair band 30 has an elongate elastic core and a textured flocked surface 32 shown by stippling. The elastic hair band 30 can form a continuous loop or ring shape. Similar to the cross-section of FIG. 2, the elastic hair band 30 has an elastic core 34 with an outer surface 36 covered by an adhesive layer 38. Flocking fibers 40 are adhered to the adhesive layer 38 so as to be adhered to the outer surface 36. As in the previous example of FIG. 1, the flocking fibers are consistently oriented generally perpendicular to the outer surface 36 of the elastic core 34. Free or exposed ends of the densely packed flocking fibers 40 form the textured flocked surface 32. The stippling in FIG. 7 represents the exposed ends of the densely packed flocking fibers 40.

FIG. 7 shows a lengthwise portion of the textured elastic hair band 30 of FIG. 6. The textured elastic hair band 30 in this example has a glued joint (not shown) that affixes free ends of a length of the elastic core 34 to form the Loop or ring shape. FIG. 8 shows a lengthwise cross sectional view of a portion of the textured elastic hair band 30 depicting the perpendicular orientation of the densely packed flocking fibers 40 to the outer surface 36 of the elastic core 34.

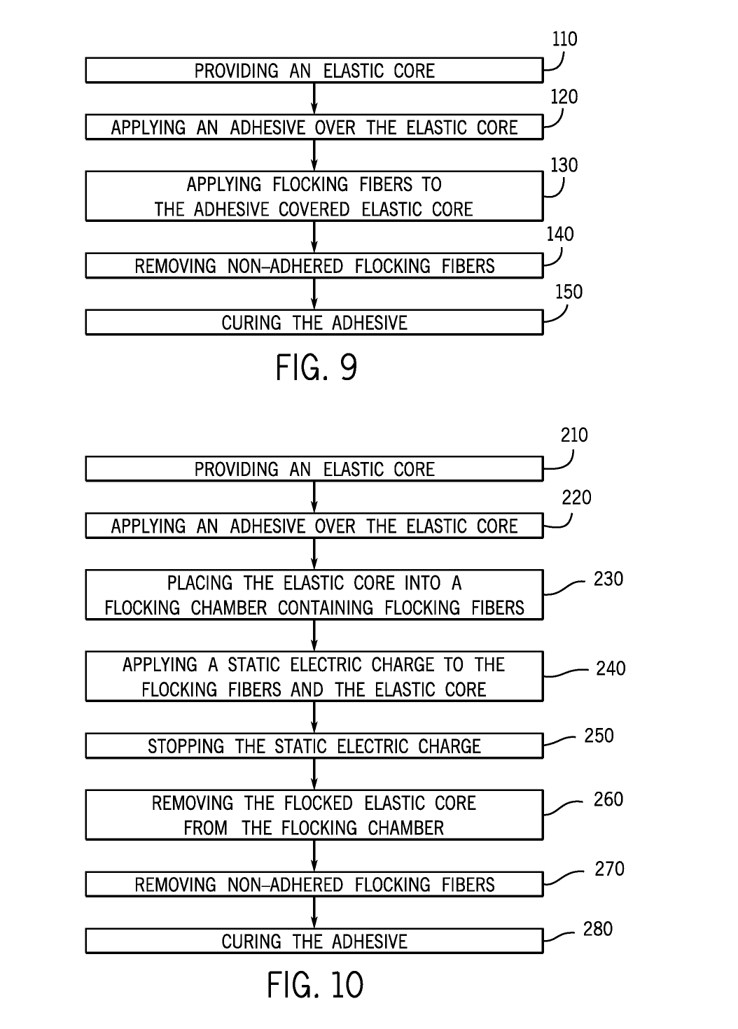

FIG. 9 shows a flow chart indicative of one example of a method of manufacturing the textured elastic hair band 10 according to the teachings of the present invention. The method includes at block 110 the step of providing an elastic core to form an elastic hair band. The elastic core can be provided in a continuous long length to form many hair bands, in shorter lengths still lengthy enough to form multiple hair bands, or in individual hair band lengths, as desired. To form the textured elastic hair band 10, the step of providing an elastic core can include providing an elastic core substrate that includes both the core material 12 and the sheath 16.

The method of FIG. 9 at block 120 includes the step of applying an adhesive material over the elastic core. A selected adhesive type must be able to stretch with the elastic core or substrate and should be capable of withstanding friction, be water resistant, be UV-stable, and be strong enough to hold flocked fibers securely to the elastic core. The adhesive material can be applied in liquid form. In the example in which providing an elastic core includes providing an elastic core substrate that includes both the core material 12 and the sheath 16, the sheath is coated with the adhesive material. In the example in which providing an elastic core includes providing an elastic core substrate that includes only the core material, the outer surface of the core material 34 is coated with the adhesive material.

The adhesive material should have characteristics that include elongation capability, stretchability, and flexibility in order to be used on the flocked elastic band, which will be stretched during use. The amount of adhesive deposited on the elastic core can also be very important. Too much adhesive applied to the elastic core can adversely affect elongation or stretchability of the elastic core. If too little adhesive is applied, the nylon flocked fibers may not securely anchor to the elastic core substrate and thus be too easily rubbed off or dislodged from the elastic core.

The method at block 130 also includes the step of applying flocking fibers to the adhesive covered elastic core. Flocking fibers can be applied by one or more methods, as discussed below. The flocking fibers can be applied in a manner so that the adhesive material adheres the fibers to the elastic core.

The flocking fibers can be formed of a nylon material in one example. Alternatively, the flocking fibers can also be formed of cotton, rayon, polyester, or the like. The flocking fibers can either be milled or cut. Milled flocking fibers can be produced from cotton or synthetic textile waste material. Because of the manufacturing process, milled flocking fibers are typically not uniform in length, and can vary from fine (about 0 to about 0.5 mm) to coarse (about 0.4 to about 1.1 mm).

Cut flocking fibers are typically produced from monofilament synthetic materials. The cutting process can produce flocking fibers having a very uniform length. Typically, lengths can be obtained from about 0.3 to about 5.0 mm and about 1.7 to about 22 dtex in diameter. One dtex is the measurement of a fiber that weighs one gram per 10,000 meters of length. The fineness of the flocking, the length of fibers, and the adhesive coating density determine the softness of the flocking. The length of the synthetic flocking fibers that may be used for a textured elastic hair band can in one example be about 1 mm.

Besides cutting or milling, flocking fiber manufacturing processes can include several additional steps. After the material is milled or cut, the flocking fibers can be cleaned of any oils that accumulated during processing. Flocking fibers can be vat dyed to any number of colors, and then chemically treated to prepare the fibers for further processing, such as to accept an electrical charge.

The method at block 140 further includes the step of removing non-adhered flocking fibers. The removal step can be done by applying suction to remove any non-adhered, loose flocking fibers. Alternatively, the removal step non-adhered flocking fibers can be done by blowing air over the flocked elastic core to remove any non-adhered flocking fibers. In another alternative, the removal step can be done by placing the flocked elastic core onto a vibration bed and vibrating the non-adhered flocking fibers off the flocked elastic core.

The method at step 150 also includes the step of curing the adhesive. The step of curing can be performed in a number of different ways. The curing step is performed in order to dry the adhesive material so that it adheres to the elastic core and so that the flocking fibers adhere to the adhesive. The step of removing the non-adhered flocking fibers can be performed before or after the step of curing the adhesive, as desired.

FIG. 10 shows a flow chart indicative of another example of a method of manufacturing a textured elastic hair band according to the teachings of the present invention. This method includes at block 210 the step of providing an elastic core. The elastic core is provided to form a substrate material for the elastic hair band 10, as in the prior disclosed method of FIG. 9. The elastic core can be provided in a continuous long length, or shorter lengths as well. As discussed above, the step of providing an elastic core can include providing an elastic core substrate that includes both the core material 12 and the sheath 16.

The method includes at block 220 the step of applying an adhesive over one or more surfaces of the elastic core. Again, this step is similar to that of the method of FIG. 9 discussed above.

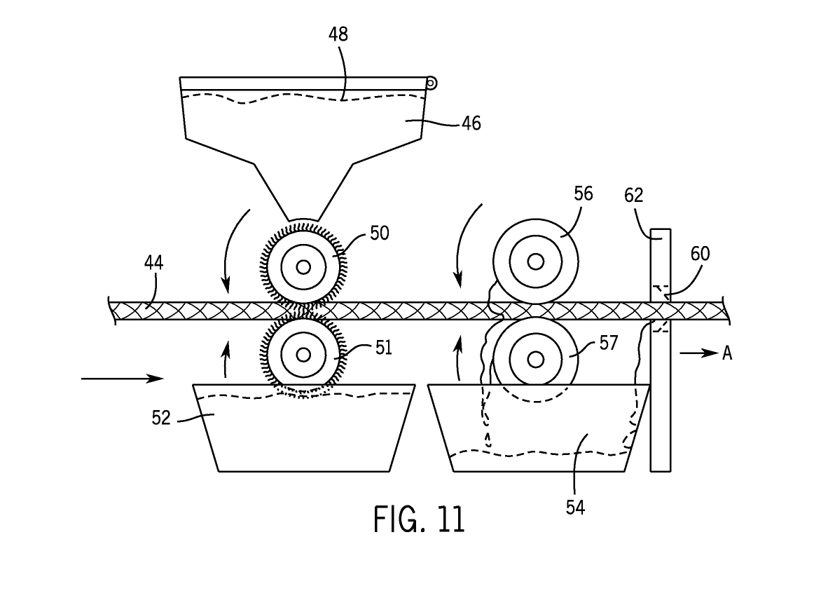

FIG. 11 shows one example of a portion of a manufacturing line for dispensing adhesive in accordance with the disclosed method of FIG. 10. A continuous length 44 of the elastic core substrate can be fed below an elevated upper tray 46, which holds a supply of adhesive material 48 in a liquid form. The upper tray 46 can feed the adhesive material 48 onto a pair of roller brushes 50, 51. The continuous length 44 travels between the pair of roller brushes 50, 51, which deposit or spread a layer of adhesive over the surfaces of the continuous length 44 of the elastic core substrate. A lower tray 52 can catch any unapplied or excess adhesive that may drip during application.

As FIG. 11 further shows, the method of FIG. 10 can optionally also include the step of removing excess adhesive materiel applied to the continuous length 44 of the elastic core substrate. Once the adhesive material has been applied, excess adhesive can be removed, thereby leaving a thin film of adhesive over surfaces of the elastic core. A number of different methods of removal may be used. For example, excess adhesive may be allowed to drip away from the elastic core and into the lower tray 54, as noted above. Excess adhesive can also be removed by passing the adhesive covered continuous length 44 of the elastic core substrate between a pair of squeegee rollers 56, 57. The squeegee rollers 56, 57 can be configured to squeeze any additional excess adhesive material from the continuous length 44 of the elastic core substrate.

Additionally or alternatively, the adhesive covered continuous length 44 of the elastic core substrate may pass through a flexible scraper 60 supported in a partition 62. The flexible scraper 60 may act as a squeegee in order to remove the excess adhesive material. Any excess adhesive that is removed may be allowed to drip away into the drip tray 54 that is positioned below the squeegee rollers 56, 57 and the partition 62. The flexible scraper or squeegee 60 can include openings of different shapes to adapt to alternate shapes of the continuous length 44 of the elastic core substrate. After the process for applying the adhesive, the continuous length 44 of the elastic core substrate can travel or be fed in the direction of arrow A for removing the excess adhesive material and then to the next station for applying the flocking fibers.

The method of FIG. 10 includes at block 230 the step of placing the elastic core in a flocking chamber that contains flocking fibers. In this example, lengths of the elastic cord can be suspended in the flocking chamber in order to ensure 360° coverage. The method can include operating the flocking chamber at a specific relative humidity and/or temperature, depending on the application process used. For example, the flocking chamber can be retained at a relative humidity in a range between about 30% and about 65% and a temperature of about 20 degrees C. (68 degrees F.).

The method can also include selecting a flocking chamber from a group of flocking chambers, each containing flocking fibers of a different color or color scheme. In this way, different textured elastic hair bands of different colors and aesthetic appearances can be created. A number of different selectable flocking chambers can be prepared and ready for use when selected. Each can contain flocking fibers of different color, length, material, or the like, depending upon the desired hair band aesthetic and performance characteristics.

Flocking fibers, depending on the material used, may generally be dielectric. Thus, a certain amount of conductivity should be present for the electrostatic flocking process to occur properly in this example. When the milling or cutting process is conducted, the flocking fibers can be spin dried and/or oven dried to achieve a specific moisture content. Flocking fibers may not be completely dried, since moisture content can enhance their conductivity.

The method also includes at block 240 the step of applying a static electric charge to the flocking fibers and the elastic core within the flocking chamber to apply, i.e. attract the flocking fibers to the elastic core. The flocking chamber can have a power unit that is turned on to create the electrostatic environment to cause the flocking fibers to become airborne and coat the length of the elastic core by penetrating the sprayed-on adhesive layer.

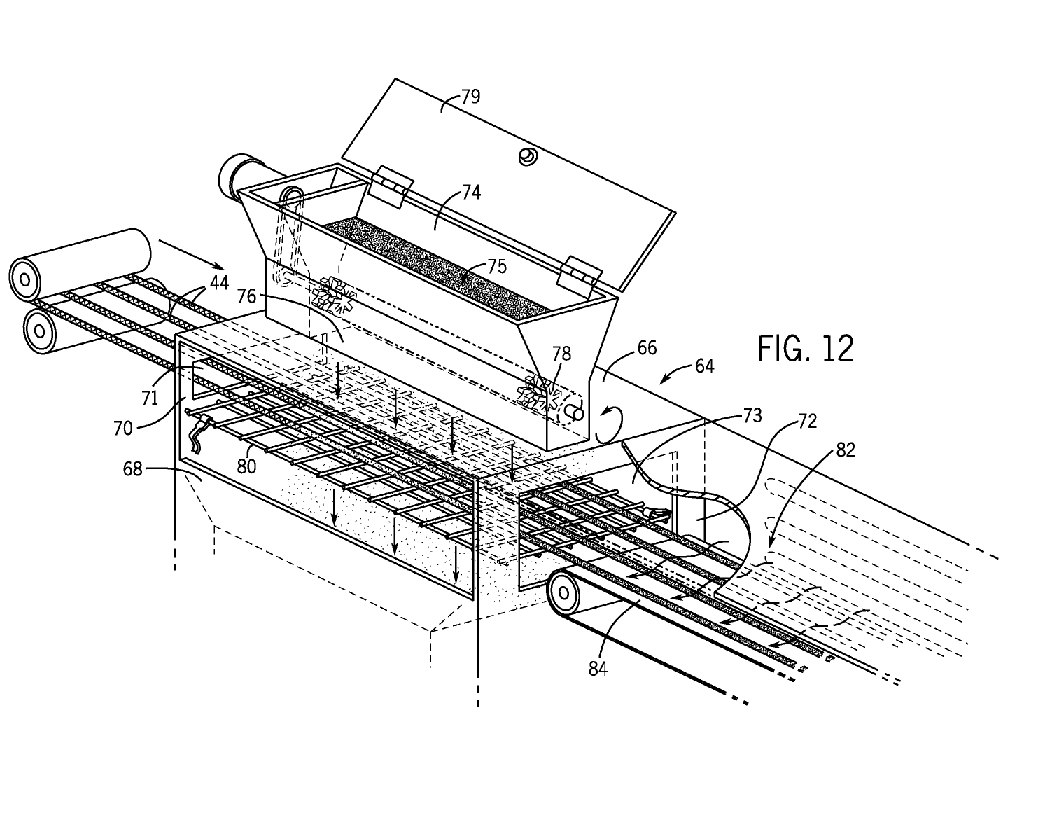

FIG. 12 illustrates one example of a portion of a manufacturing line to apply flocking fibers to the adhesive covered continuous length 44 of the elastic core substrate. A flocking chamber 64 has a top side 66, a bottom side 68, a first end wall 70, and a second end wall 72. A first opening 71 is provided in the first end wall 73 through which the adhesive covered continuous length 44 enters the flocking chamber 64. A second opening 73 is provided in the second end wall 72 through which the flocked continuous length exits the flocking chamber 64. In one example, one continuous length 44 of the elastic core substrate can be fed through the flocking chamber 64 at a time or single discrete lengths of elastic core can be fed through the chamber at a time. Alternatively, multiple discrete length or multiple continuous lengths 44 of elastic core substrate can be fed through the chamber 64 and flocked at once, as shown. The first and second openings 71, 73 can have coverings that are flexible flaps of vinyl or other suitable material. The flaps can be provided to retain flocking fibers inside the chamber 64 yet allow the elastic core substrate or continuous lengths 44 to be fed continuously into and through the chamber.

The top side 66 of the flocking chamber 64 in this example is fitted with a flocking hopper 74, which holds flocking fibers 75. The flocking hopper 74 can be generally V-shaped with an opening 76 at the bottom. The opening 76 can be in communication with an inside of the flocking chamber 64 via a corresponding opening. The hopper 74 can also have an agitator bar 78 or other means at the opening 76 in order to feed and disperse the flocking fibers 75 from the hopper 74 into the chamber 64. The flocking hopper 74 can also have a cover 79 to retain the flocking fibers 75. The flocking fibers 75 can be fed into the chamber 64 at a prescribed rate in order to reduce waste. A metal grid 80 is provided inside the flocking chamber 64 for applying the electrostatic charge. The metal grid 80 is supported near to and above the bottom side 68 of the chamber 64. The chamber 64 can have a second metal grid (not shown) that is positioned above the length or lengths 44 of the elastic core substrate in the chamber. The chamber 64 can also include a container for collecting excess flocking fibers at the bottom and below the grid 80.

The disclosed electrostatic application method can be used to produce suitable results for flocking elastic core material. The disclosed method of FIGS. 10-12 can consistently orient and align the flocking fiber generally perpendicular to the outer surface of the elastic core substrate material. In an electrostatic flocking process according to the invention, the electrical charge can be generated by creating two electrodes. One can be a high voltage, direct current grid disposed in the flocking chamber and connected to a power generator. The other can be created by grounding the elastic core material to be flocked. The electrostatic charge that is generated propels the fibers at a high velocity into contact with the adhesive material on the continuous length 44 of the elastic core substrate. This causes the flocking fibers 75 to penetrate and imbed in the adhesive material at right angles to the outer surfaces of the substrate. This forms a high density, uniform, flocked coating or layer over the continuous length 44. Controlling the electrical field by increasing or decreasing either the applied voltage or the distance between the electrodes (i.e., the grid and the continuous length 44 of the elastic core substrate controls the application speed and thickness of the flocking fibers.)

As noted above, it may be important to control the environment of the flocking chamber 64 in order to obtain optimal adhesion results of the flocked fibers 75 to the adhesive material 48. The flocking chamber 64 and surrounding area should, in one example, have a relative humidity of about 60% and a temperature of about 20° C. (68° F.). Less than 30% relative humidity in the production area can lead to fibers that will not accept a charge. Relative humidity in excess of 65% can cause the flocking fibers to stick together and flow poorly through the flocking hopper 60, and particularly the opening 76, which may include a metal screen or plate. Small variations in temperature or changes in the relative humidity may result in a change of several factors in the conductivity or electrical sensitivity of the flocking fibers 75 and the continuous length 44 of the elastic core substrate. Such changes can potentially have an adverse effect on the process. Flocking fibers 75 can be sensitive to humidity and temperature conditions. When the humidity and temperature are not suited to the particular flocking material selected, the flocking fibers may clump or “ball,” may not adequately adhere, and may become too dense resulting in an excessive use of the flocking fibers. When each new batch of flocking fibers is opened, the fibers give off or receive moisture based on the surrounding environment. Thus, it may be important that each new batch be opened in the controlled environment to maintain desired moisture content.

The method of FIG. 10 further includes at block 250 the step of stopping the electric charge after a period of time that is sufficient to allow the adhesive material 48 to adhere the flocking fibers 75 to the continuous length 44 of the elastic core substrate. The flocking fibers should also be allowed sufficient time to achieve proper coverage of the fibers over the adhesive material 48 and the elastic core.

The method also includes at block 260 the step of removing the flocked elastic core from the flocking chamber 64. The continuous lengths 44 of flocked elastic core should still to be treated with care as the adhesive is likely not yet cured.

In other examples, the flocking fibers can be applied to the elastic core material using gravity or a puffer, can be blown or sprayed onto the elastic core material, or can be applied using other suitable transfer application methods. These methods merely distribute a flock layer onto the surface. Using such alternate application methods, the flocking fibers may be randomly adhered to the surface of the substrate at different depths and orientations. This may create an irregular flocked surface similar to felting. The elastic core substrate can be mechanically vibrated after such application methods in order to promote the formation of a dense layer of fibers.

The method can still further include at block 270 the step of removing non-adhered flocking fibers from the elastic core. This step can be conducted while the continuous lengths 44 of core substrate remain in the flocking chamber 64 or after the substrate has exited the chamber. As noted above, the step of removing can be done by applying suction to remove the non-adhered flocking fibers. Alternatively, the step of removing can be done by blowing air over the flocked elastic core to remove any non-adhered flocking fibers. As an additional alternative, the step of removing can be done by placing the flocked elastic core onto a vibration bed and vibrating the non-adhered flocking fibers off the flocked elastic core.

The method of FIG. 10 also includes at block 280 the step of curing the adhesive. The step of removing the non-adhered flocking fibers 75 can be performed before or after the step of curing the adhesive material 48.

As FIG. 12 also shows, once the length or lengths 44 of flocked substrate exit the flocking chamber 64, the substrate can be placed in an oven 82 for curing. Alternatively, the lengths of substrate can be continuously fed through the oven 82 via a conveyor 84 for curing. The oven 82 can contain heating elements over and/or under which the substrate passes for a sufficient length of time and at an optimal temperature. The flocked elastic core can be placed or suspended in an oven for a period of time at an effective temperature, for example for 20-23 minutes at 80° C. A proper curing phase can be important because the adhesive material 48 should not be overheated, which can otherwise reduce its effectiveness or can negatively affect desired performance characteristics.

In another example, the step of curing can be performed by exposing the flocked elastic core to ultraviolet light in order to cure the adhesive. The flocking chamber can be flowed by a station along the manufacturing line that has a UV light source or sources directed at the one or more flocked surfaces of the flocked elastic core.

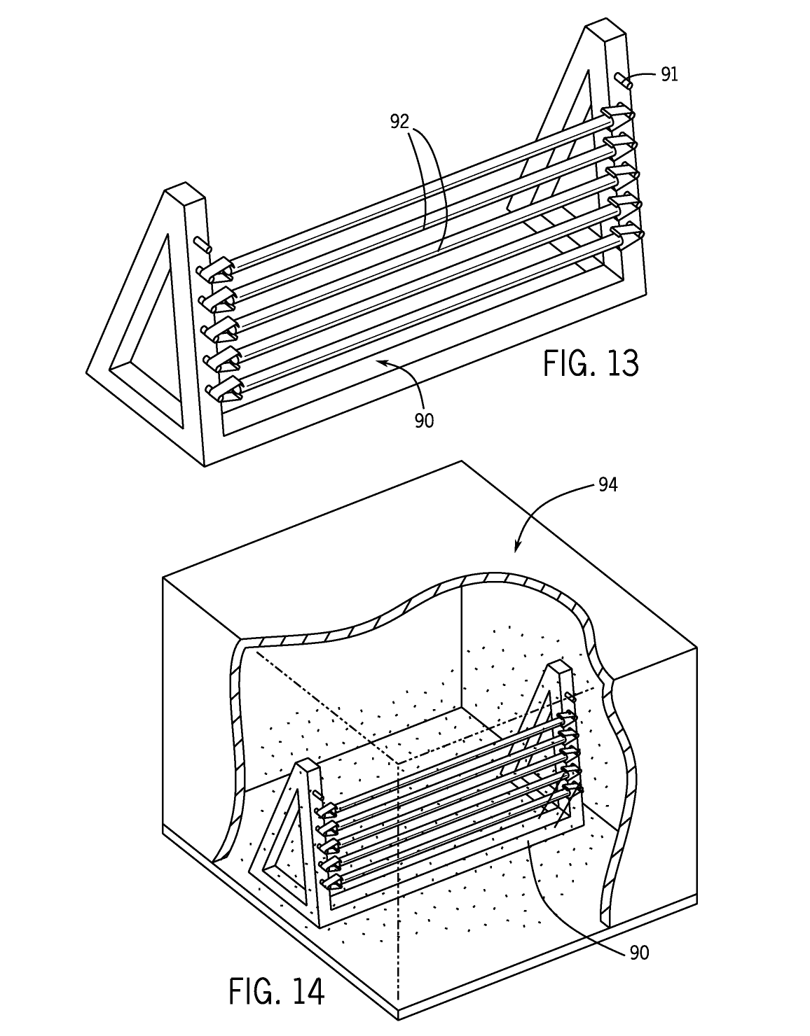

As will become evident to those having ordinary skill in the art upon reading this disclosure, the methods disclosed herein can be varied from the examples shown and described. For example, in one alternative, the elastic core can be cut to selected lengths prior to flocking. FIG. 13 shows an example of a metal fixture or frame 90. Such a frame 90 can have pins or pegs 91 that can be used to hold shorter lengths of elastic core 92 to which adhesive has been applied or will be applied. As shown in FIG. 14, the frame 90 can be placed in or can slide into a flocking chamber 94. Once the frame 90 is placed into the chamber 94, the chamber can be closed and the flocking fibers can be applied as noted above. One or more frames can be placed in the chamber at a time, depending on the sizes of the frames and the chamber. The metal frame 90 can be used in the electrostatic or other application methods.

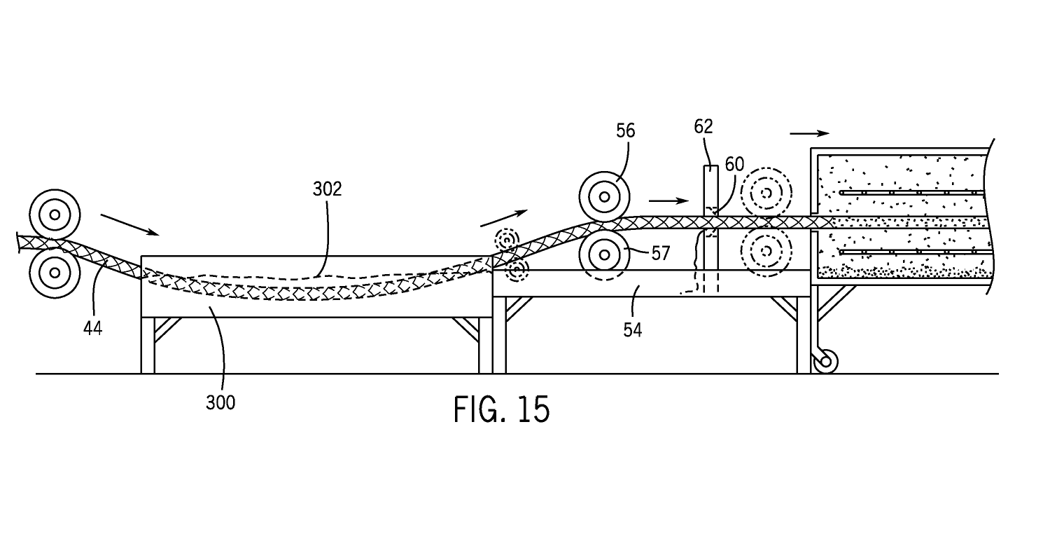

In another example, the adhesive material can be applied using other methods, such as by dipping the elastic core into the liquid adhesive, spraying the adhesive onto the elastic core, or by a gravity feed method. FIGS. 15-17 illustrate other alternative methods for applying the adhesive material to the elastic core. The elastic core may be rectangular, flat, oval, or circular with any of these methods of adhesive application. As shown, the elastic core includes the textile woven sheath, but can instead include only the elastic material.

As shown in FIG. 15, a dip tank 300 contains adhesive material 302 in a liquid form. The adhesive material 302 can be applied to an elastic core 44 by dipping the core 44 into the dip tank 300. A long length of the elastic core 44 can be continuously fed or pulled into, though, and out of the dip tank 300. Alternatively, shorter lengths of elastic core can be dipped. The dip tank 300 can also have a cover.

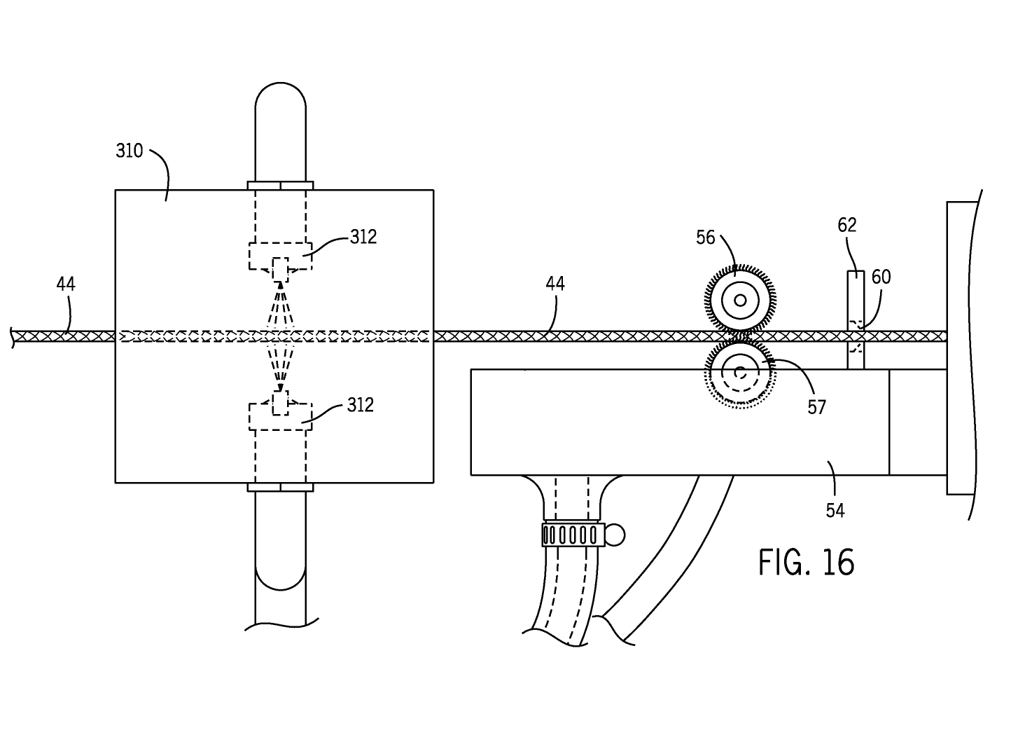

FIG. 16 shows a spray chamber 310 having spray heads 312. Two spray heads 312 are provided in this example, but a different number and arrangement of the spray heads can be used so as to cover all surfaces of an elastic core 44 with adhesive material. Spray operations can be continuous if the elastic core 44 is fed continuously through the spray chamber 310. Alternatively, the spray operations can be discontinuous so as to spray shorter discrete sections of the elastic core placed in the spray chamber. Further, the liquid adhesive can be thinned down as needed for a spraying application.

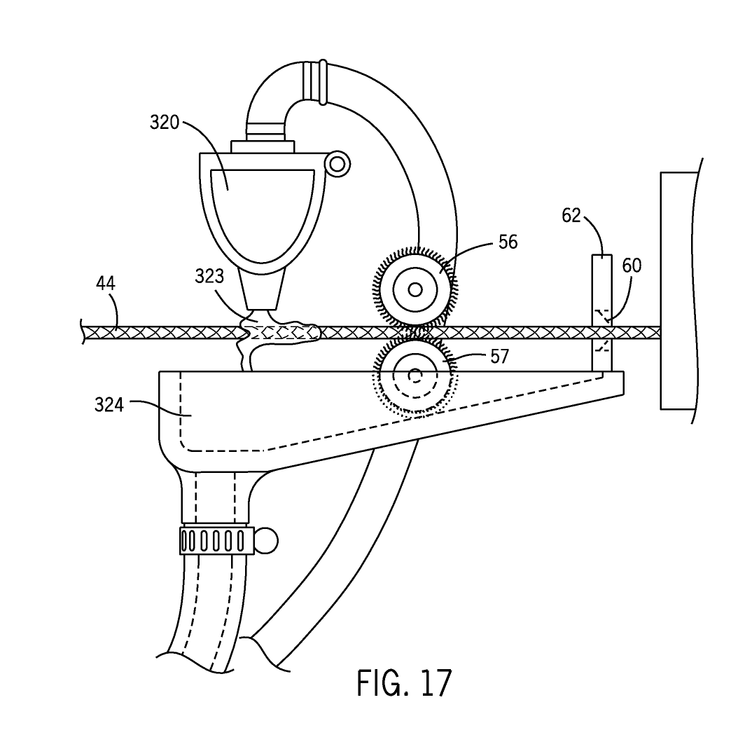

In another example, FIG. 17 shows the application of adhesive material via gravity feed. The adhesive material in a liquid form is contained in a reservoir 320. The size of the reservoir 320 can be determined by a desired run rate of the adhesive relative to a rate at which the elastic core 44 is passed under the reservoir 320. The adhesive material 323 is allowed to flow over surfaces of the elastic core material 44. The adhesive material 323 then flows into a lower reservoir 324 from which it may be recirculated to the upper reservoir 320. The lower reservoir 324 can also function as a drip tray to catch excess adhesive material dripping off the elastic core 44.

As discussed above with regard to FIG. 11, FIGS. 15-17 also show that once the adhesive material has been applied, excess adhesive may be removed. Common reference numbers are used to show the common elements on each of the additional figures.

After the flocked elastic core is cured, the disclosed methods can include additional steps of cutting the flocked elastic core to a selected length and gluing cut ends of the elastic core. For example, the ring or loop shaped textured elastic hair band 10 has a seam 22 as shown in FIGS. 1 and 3. Gluing cut ends together forms a previously straight length of flocked elastic core material into the textured elastic hair band 10 having the loop or ring shape. The textured surface then appears continuous over the entire hair band.

In addition to the methods discussed above, flocking fibers can also can be sprayed using an air compressor, reservoir, and spray gun similar to spraying paint. The resulting finish using this method may be similar to a thin felt coating, as most of the fibers may be lying down in the adhesive material, producing a result different than that produced by the electrostatic method. Spraying may be used primarily when large surface areas require flocking. Flocking can also be applied by printing an adhesive onto a substrate, and then rapidly vibrating the substrate mechanically, while the flock fibers are dispensed and dispersed over the surface. Vibration can promote a dense layer of flocking fibers that securely adhere to the adhesive material.

Headbands, claw clips, and any other possible hair accessories may form a substrate to which flocking fibers can be applied for improved performance and according the methods of the present invention.

Although certain flocked elastic bands and methods of manufacturing them have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A textured elastic hair band comprising:
an elastic core substrate;
a sheath of textile fibers covering the elastic core substrate; and
flocking fibers secured to the sheath.

2. The textured elastic hair band according to claim 1, wherein the textile fibers are helically woven and the sheath covers the entire elastic core substrate.

3. The textured elastic hair band according to claim 1, wherein the flocking fibers are oriented generally perpendicular to the outer surface of the sheath.

4. The textured elastic hair band according to claim 1, wherein the elastic core substrate is a loop or ring shape.

5. The textured elastic hair band according to claim 1, further comprising an adhesive material layer on the outer surface of the sheath, the flocking fibers being adhered to the adhesive material layer.

6. A method of manufacturing a textured elastic hair band, the method comprising the steps of:
a) providing an elastic core including an elastic core substrate and a sheath of textile fibers over the elastic core substrate;
b) applying an adhesive material over one or more portions of an outer surface of the sheath;
c) exposing the elastic core to flocking fibers so that flocking fibers are secured to the elastic core by the adhesive material;
d) removing non-adhered flocking fibers from the elastic core; and
e) curing the adhesive material.

7. The method according to claim 6, wherein step c) further comprises steps of:
placing the elastic core in a flocking chamber containing the flocking fibers;
applying a static electric charge to the flocking fibers and the elastic core for a period of time sufficient to attract the flocking fibers to the elastic core and for the flocking fibers to adhere to the one or more portions of the outer surface of the sheath;
stopping the static electric charge after the period of time; and
removing the flocked elastic core from the flocking chamber.

8. The method according to claim 6, wherein step b) further comprises spraying the adhesive material in liquid form onto the elastic core.

9. The method according to claim 6, wherein step b) further comprises dipping the elastic core into the adhesive material.

10. The method according to claim 6, step b) further comprises removing excess adhesive material from the elastic core.

11. The method according to claim 6, further comprising a step of cutting monofilament synthetic material to uniform length fibers to form the flocking fibers.

12. The method according to claim 6, further comprising a step of milling the flocking fibers to a non-uniform length.

13. The method according to claim 6, further comprising a step of selecting a flocking chamber from a group of flocking chambers each containing flocking fibers of a different color or color scheme.

14. The method according to claim 6, wherein step c) further comprises operating a flocking chamber at a relative humidity in a range between about 30% and about 65% and at a temperature of about 20 degrees C. (68 degrees F.).

15. The method according to claim 6, wherein step d) comprises blowing air over the flocked elastic core to remove the non-adhered flocking fibers.

16. The method according to claim 6, wherein step d) comprises applying suction to the flocked elastic core to remove the non-adhered flocking fibers.

17. The method according to claim 6, wherein step d) comprises placing the flocked elastic core onto a vibration bed and vibrating the non-adhered flocking fibers off the flocked elastic core.

18. The method according to claim 6, wherein step e) comprises placing the flocked elastic core in an oven.

19. The method according to claim 6, wherein step e) comprises exposing the flocked elastic core to ultraviolet light.

20. The method according to claim 6, further comprising the steps of:
cutting the flocked elastic core into multiple selected lengths; and
gluing cut ends of each of the multiple selected lengths together to form multiple loop or ring shaped textured elastic hair bands.

21. The method according to claim 6, wherein step c) further comprises applying an electrostatic charge to the flocking fibers and the elastic core.

22. A textured elastic hair band comprising:
an elastic core; and
flocking fibers secured to an outer surface of the elastic core.

23. The textured elastic hair band according to claim 22, wherein the elastic core comprises an elastic core substrate and a sheath of textile fibers over the elastic core substrate, and wherein the flocking fibers are secured to the sheath of textile fibers.

24. The textured elastic hair band according to claim 22, wherein the flocking fibers are secured directly to the outer surface of the elastic core by an adhesive material.

25. The textured elastic hair band according to claim 22, wherein the flocking fibers are oriented generally perpendicular to the outer surface of the elastic core.

26. The textured elastic hair band according to claim 22, wherein the elastic core is a loop or ring shape.
